(19) United States
(12) Patent Application Publication
(10) Pub. No.: US 2025/0252875 A1
(43) Pub. Date: Aug. 7, 2025

(54) TABLETOP DISPLAY DEVICE FOR ADVERTISING INFORMATION WITH WIRELESS CHARGING SUPPORT

(71) Applicant: Topolo Technology Inc., Lewes, DE (US)

(72) Inventor: Ashley Michael James Lane, Dubai (AE)

(73) Assignee: Topolo Technology Inc., Lewes, DE (US)

(21) Appl. No.: 18/706,758

(22) PCT Filed: Nov. 1, 2022
(86) PCT No.: PCT/US2022/079009

§ 371 Date: May 2, 2024

(51) Int. Cl. G09F 23/06; G06F 1/16; G06Q 30/0251; G09F 9/302; G09F 27/00; H01M 10/46

(52) U.S. Cl. CPC G09F 23/06; G06F 1/1626; G06F 1/1632; G06Q 30/0267; G09F 9/302; G09F 27/00; H01M 10/46; G09F 2027/001

(57) ABSTRACT

The present invention discloses a portable tabletop device configured to display advertisement data and information related to goods and services. Such information relating to goods and services may include menus for receiving orders, requesting a server, repeating the last order, connecting to in-house Wi-Fi, and receiving feedback from the customers. Side-by-side charges multiple electronic devices via wired and wireless connections. The tabletop device includes one or more display units provided at the side surfaces of the device that allows the users or viewers to view the displayed information from multiple directions. The tabletop device further includes a plurality of charging ports to provide wired charging support and an inductive charging unit for wirelessly charging electronic devices. Moreover, the tabletop device can be wirelessly charged by a docking station. The docking station further includes a plurality of receptacle that receives multiple tabletop devices.

### TECHNICAL FIELD

The present invention relates generally to a display device for displaying or presenting information and providing wireless charging support to multiple electronic devices such as smartphones, tablets, etc., More particularly, the present invention relates to a tabletop display device that displays menus, advertisements, promotions, services, and features and is configured to be used in hotels, bars, restaurants, cafes, airports, hospitals, events, and the like. Moreover, the tabletop device of the present invention also offers charging for multiple electronic devices via wired or wireless connectivity.

### BACKGROUND ART

The term “Advertising” refers to marketing communication that employs an openly sponsored, non-personal message to promote or sell a product, service, or idea. Various places of business provide excellent opportunities for the presentation of advertising materials to the public. For example, restaurant patrons are effectively a captive audience for any advertising materials placed within their purview. The same principle holds for numerous other types of places of business, including hospitals, cafes, offices, airports, public stations, and even hotel or motel rooms. Advertisement through display devices is a known method to promote one's product and services. A tabletop display device or table advertising player is one of the types of display devices used in restaurants, hotels, hospitals, bars, and cafes for advertisement purposes.

Presently, tabletop devices are being employed in various industries for multiple purposes. One such application, the tabletop device, can act as an ordering device in restaurants, hotels, cafes, bars, and the like to take orders. Also, in healthcare, the tabletop device facilitates the users to make an appointment and provides an online medical facility for diagnosis purposes. In other applications, the tabletop device may also display information and notices related to work, mainly in offices. To perform these tasks, the display units of the tabletop devices need to be always on, which leads to more power consumption.

Furthermore, the available tabletop devices also include a plurality of charging cables that facilitate users to charge their mobile phones or other digital gadgets while watching advertisements and information related to goods and services on the display units. Unfortunately, the charging feature of the tabletop device also leads to more power consumption. Due to the wide variety of uses, the conventionally available tabletop device suffers a considerable amount of battery consumption, resulting in poor efficiency. In order to work efficiently and effectively, the tabletop devices need to be charged multiple times during the day. Charging the available tabletop devices itself is a very time-consuming and complex task.

To charge the plurality of tabletop devices, a venue owner has to collect the multiple devices individually and plug them into the numerous power sockets, which leads to a bad user experience and inconveniences. The power socket can charge one tabletop device at a time and takes more time to charge multiple devices. Due to the inability to charge multiple devices together in less time, the objective of using these devices is not achieved. Furthermore, the available tabletop devices also require a separate cable and an electrical socket to charge their batteries. The charging cable and other accessories, such as electrical sockets and plugs, occupy more space and cause inconvenience to the users. Thus, due to the non-uniform storage solution in the existing devices, it is challenging to rechange all the tabletop devices effectively and store them in a manner where they occupy much less table area.

Conventionally available tabletop devices provide an enhanced experience to users while ordering food in restaurants, cafes, and the like when compared to traditional booking methods. The tabletop device with a single display screen allows users or viewers to view the advertisement from one direction only. For example, suppose a person is sitting at the event location at a round table, especially in the case of restaurants and cafes, and wants to see the advertisement from another direction (behind the device). In that case, he has to move the display screen towards his side. The conventional approach of displaying the advertisement also affects the customer's viewing angle, allowing only a limited view of the display.

In available tabletop devices, uploading the advertisement content and the information related to goods and services into the device is also very time-consuming. Nowadays, tabletop device uses a wired or wireless medium to transfer data between devices. In traditional approaches, the venue owners and advertisers need to install the software application on the tabletop devices to upload advertisement data. Once the required software application is installed, the tabletop device is available to receive and transmit data. The installed application also requires a plurality of updates and licensing from time to time. Therefore, the conventional approach of uploading and transmitting data delays the data transfer and cannot provide timely advertisements, promotions, and notifications to the customers. Furthermore, these approaches are limited to certain functions and do not provide users sufficient space to modify or create advertisements and campaigns according to their needs.

The United States patent document US20150303727A1 titled ‘Portable device charging apparatus’ discloses a portable charging apparatus that allows several people to charge their devices conveniently. The portable charging apparatus includes a display unit configured to display contents such as advertisements, and promotions, such that users are naturally exposed to the advertisement while charging their devices. The portable charging apparatus includes a pair of electrodes configured to transmit the electric power to the user's device to charge them. However, the apparatus mentioned in the patent document does not support wireless charging and is limited to a single display unit for advertisement purposes.

The United States patent document US20040103570A1 titled ‘Three-dimensional advertising display and associated method of use’ discloses a display device having a triangular structure and is configured to display the advertisement from three sides. The display device includes a plurality of display units (preferably three) positioned on the three different sides of the device. However, the display device mentioned in the patent document does not support wireless charging and is not able to connect with other similar devices. Furthermore, it does include a charging port to provide charging support to users.

Therefore, there is a need for a tabletop device that displays the advertisement, promotions, and menus related to the goods and services on time and charges multiple electronic devices, including smartphones, tablets, notebooks, and the like, through wired or wireless connection medium. There is also a need for a charging station or docking station that allows users to charge multiple tabletop devices simultaneously in a more convenient way. Moreover, the required tabletop device accepts and transfers the advertisement data, regularly updates the content more conveniently, and solves the deficiencies associated with the prior arts.

### OBJECTS OF THE INVENTION

Some of the objectives of the present invention are as follows:

It is an objective of the present invention to provide a tabletop device that displays and advertises information related to goods and services in a convenient manner.

It is an objective of the present invention to provide a tabletop device that includes one or more display units provided on the side surfaces of the device and displays the advertisement in multiple directions.

The present invention aims to provide a tabletop device configured to charge multiple electronic devices such as smartphones, smartwatches, notebooks, tablets, laptops, handheld computing devices, personal digital assistants (PDA), and the like.

It is an objective of the present invention to provide a tabletop device that receives the advertisement data and information related to goods and services, from other computing devices or external cloud servers via a wireless medium.

A further objective of the present invention is to provide a tabletop device that employs a Saas (software-as-a-service) technology to upload advertisement data and information related to goods and services.

It is a further objective of the present invention to provide a tabletop device that charges the plurality of electronic devices via a wired or wireless medium.

It is a further objective of the present invention to provide a tabletop device that includes a plurality of sensors for detecting the number of people near the device and capturing their images via a camera unit.

It is a further objective of the present invention to provide a tabletop device that enables the viewers to view the advertisement or information related to goods and services from multiple viewing angles.

It is a further objective of the present invention to provide a tabletop device comprising a plurality of USB ports for charging multiple electronic devices simultaneously and also includes an inductive unit configured to charge the electronic devices wirelessly.

It is a furthermore objective of the present invention to provide a docking station configured to charge the plurality of tabletop devices through a wireless medium or electrical terminal.

It is a furthermore objective of the present invention to provide a docking station that includes a connecting terminal for connecting or charging the multiple docking stations together.

It is a furthermore objective of the present invention to provide a docking station that includes a plurality of receptacles for receiving multiple tabletop devices and firmly holds them through a locking mechanism.

It is a furthermore objective of the present invention to provide a docking station that includes an in-built fan to remove the excess heat of the station while charging the plurality of tabletop devices and other docking stations.

It is a furthermore objective of the present invention to provide a tabletop device that can be used as a table advertising player in restaurants, cafes, hotels, hospitals, railway stations, airports, events, offices, and the like.

It is a furthermore objective of the present invention to provide a tabletop having a water-proof enclosure and provides effective sealing against foreign bodies such as objects, water, dirt, and the like.

It is a furthermore objective of the present invention to provide a tabletop device that is cost-effective, simple, portable, and convenient to use.

Other objects, aspects, features, and goals of the present invention will be better understood from the detailed description.

### SUMMARY

The present invention is described hereinafter by various embodiments. However, this invention may be embodied in many different forms and should not be construed as limited to the embodiment set forth herein. Rather, the embodiments are provided so that this disclosure will be thorough and complete and fully convey the invention's scope to those skilled in the art.

In accordance with the first aspect of the present invention, there is provided a tabletop device for displaying or advertising an information related to goods and services, said tabletop device comprising: one or more display units for displaying the said advertisement, wherein said one or more display units is provided on the side surfaces of said tabletop device; a plurality of charging port for charging a plurality of electronic devices via a wired or cable connection; an induction charging unit for charging said plurality of electronic devices that supports wireless charging function, wherein said induction charging unit transmits the power to electronic devices wirelessly; a control unit for controlling at least one feature of said tabletop device; a processor configured to process the information related to said goods and services for advertisement purpose; a memory unit for storing the information related to goods and services; a wireless transceiver configured to transmit and receive the information related to goods and services wirelessly from other computing devices, in some embodiments, the data and information can be uploaded or downloaded from the cloud server; and a power source for providing the electric power to said tabletop device.

In one embodiment of the present invention, said display unit includes a liquid crystal display (LCD), light-emitting diode (LED) display, organic light-emitting diode (OLED) display, active-matrix organic light-emitting diode (AMOLED), electroluminescent display (ELD), thin-film transistor display (TFT), plasma display, quantum-dot display (QLED), and the like.

In one embodiment of the present invention, said charging port includes a Universal Serial Bus (USB) A, B, or C type design or any other proprietary design depending upon the application of the said tabletop device.

In one embodiment of the present invention, said induction charging unit includes an induction coil, preferably made of copper, that produces a magnetic field when the electric current passes through it.

In one embodiment of the present invention, said plurality of electronic devices includes a smartphone, tablet, notebook, smartwatch, handheld computing device, personal digital assistant (PDA), and any other computing device that supports wireless charging.

In one embodiment of the present invention, the advertisement data and information related to said goods and services can be transmitted to said tabletop devices through a wireless medium.

In one embodiment of the present invention, the wireless medium includes but is not limited to Bluetooth, ZigBee, Ethernet, Wireless Fidelity (Wi-Fi), Near Field Communication (NFC), and the like.

In one embodiment of the present invention, the advertisement data and information related to goods and services can be transferred from a remote server through a SaaS-based technology, wherein “SaaS or software-as-a-service” delivers applications over the internet as a service. Instead of installing and maintaining software, users can simply access it via the internet, freeing them from complex software and hardware management. The SaaS technology allows venue owners and advertisers to create adverts and campaigns that automatically sync across the network used for the tabletop device. The SaaS technology further provides users an enhanced and much-improved working experience.

In one embodiment of the present invention, the tabletop device may include a camera unit configured to capture the viewers' images, perform facial recognition technology, and analyze their physical activities.

In one embodiment of the present invention, the tabletop device may include a near-field communication (NFC) chip for transaction purposes and is configured to exchange data between readers and payment devices.

In one embodiment of the present invention, the tabletop device may include a proximity sensor such as an infrared sensor for detecting the presence of the viewers near the tabletop device, wherein the proximity sensor includes an inductive proximity sensor, optical proximity sensor, capacitive proximity sensor, magnetic proximity sensor, ultrasonic proximity sensor and the like.

In one embodiment of the present invention, the tabletop device may include a projecting unit that projects visual features such as logos related to said goods and services for advertisement purposes.

In one embodiment of the present invention, the tabletop device may include a speaker or alarming unit for the audio output and a microphone for receiving the audio signals.

In one embodiment of the present invention, the tabletop device may include a physical or virtual SIM (subscriber identity module) card to provide 4G and 5G connectivity.

In one embodiment of the present invention, the tabletop device is generally made of water-proof material and offers effective sealing against dirt, spillage, and water particles.

In one embodiment of the present invention, the power source preferably includes one or more rechargeable batteries that provide electric power to the tabletop device.

In one embodiment of the present invention, the rechargeable battery of the tabletop device is selected from a group of lead-acid, nickel-cadmium (NiCd), nickel-metal hydride (NiMH), lithium-ion (Li-ion), lithium-ion polymer (LiPo), or rechargeable alkaline batteries.

In one embodiment of the present invention, the rechargeable batteries of the said tabletop device can be charged via a docking station, wherein the docking station includes a plurality of receptacles for receiving the plurality of tabletop devices.

In one embodiment of the present invention, the tabletop device includes a Wireless-Fidelity (Wi-Fi) repeating hardware configured to extend the coverage area of the device's Wi-Fi network. The Wi-Fi repeater receives the existing Wi-Fi signal, then amplifies the received signal to extend the coverage area. The tabletop device also includes a hotspot feature to enable the users to use the internet at a location near the tabletop device.

In one embodiment of the present invention, the tabletop device engages with the receptacle of the docking station through a locking mechanism that holds the tabletop device firmly within the receptacle. The locking mechanism includes a magnetic mechanism, snap and fit mechanism, and the like.

In one embodiment of the present invention, the docking station further includes a plurality of charging pads on which the tabletop devices are placed and configured to wirelessly charge the tabletop device. In some embodiments, the docking station may include a plurality of electrical terminals that connects with the respective terminals of the tabletop device to charge the tabletop device.

In one embodiment of the present invention, the docking station may include a connecting terminal configured to connect multiple docking stations and charge multiple docking stations simultaneously. The docking station can charge the other docking station through the connecting terminals.

In one embodiment of the present invention, the docking station further includes an in-built fan that helps in removing or reducing the excess heat produced while charging multiple tabletop devices and other docking stations.

The following detailed description is illustrative and is not intended to be limiting. In addition to the illustrative aspects, embodiments, and features described above, further aspects, embodiments, and features will be apparent by reference to the following detailed description in conjunction with the accompanying drawings.

### BRIEF DESCRIPTION OF DRAWINGS

So that how the above-recited features of the present invention can be understood in detail, a more particular description of the invention, briefly summarized above, may have been referred to by examples, some of which are illustrated in the appended drawings. However, it is to be noted that the appended drawings illustrate only typical examples of this invention and are therefore not to be considered limiting of its scope, for the invention may admit to other equally effective examples.

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein reference letters and numerals indicate the corresponding parts in various figures in the accompanying drawings, and in which:

FIG. 1 illustrates a perspective view of a tabletop device in accordance with an embodiment of the present invention;

FIG. 2 illustrates a schematic block diagram of the internal components of the tabletop device disclosed in FIG. 1, in accordance with an embodiment of the present invention;

FIG. 3 illustrates a schematic configuration of the tabletop device with the plurality of electronic devices and wireless transmission with the other computing devices, in accordance with an embodiment of the present invention;

FIG. 4 illustrates a perspective view of a docking station that receives the multiple tabletop device, in accordance with an embodiment of the present invention;

FIG. 5 illustrates the communication between the two docking stations, in accordance with an embodiment of the present invention;

FIG. 6 illustrates a perspective view of the tabletop device in accordance with an alternate embodiment of the present invention; and

FIG. 7 illustrates a perspective view of the tabletop device in accordance with an alternate embodiment of the present invention.

While the present invention is susceptible to various modifications and alternative forms, specific embodiments are shown by example in the drawings and will be described in detail herein. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims and equivalents thereof.

### DETAILED DESCRIPTION OF THE PRESENT INVENTION

Embodiments of the present invention disclosure will be described more fully hereinafter with reference to the accompanying drawings in which numerals represent like elements throughout the figures, and in which example embodiments are shown.

While the present invention is described herein by way of example using embodiments and illustrative drawings, those skilled in the art will recognize that the invention is not limited to the embodiments of drawings or drawings described and is not intended to represent the scale of the various components. Further, some components that may form a part of the invention may not the illustrated in certain figures, for case of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e., meaning having the potential to) rather than the mandatory sense (i.e., meaning must). Further, the words “a” or “an” means “at least one” and the word “plurality” means “one or more” unless otherwise mentioned. Furthermore, the terminology and phraseology used herein are solely used for descriptive purposes and should not be construed as limiting in scope. Language such as “including,” “containing”, “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of document acts, materials, devices, articles, and the like are included in the specification solely to provide a context for the present invention.

It is not suggested or represented that any or all of these matters form part of the prior art base or were common general knowledge in the field relevant to the present invention.

The present invention discloses a portable tabletop device configured to display the advertisement data and information related to goods and services and side-by-side charges the multiple electronic devices via wired and wireless connection. The tabletop device includes one or more display units provided at the device's side surfaces, allowing the users or viewers to view the displayed information from multiple directions. Furthermore, the tabletop device employs a SaaS-based technology to upload content from a remote server or other computing devices, enabling users to create adverts according to their needs. Furthermore, the tabletop device includes a plurality of charging ports to charge the device via a wired connection and an inductive charging unit for wirelessly charging the electronic devices. Moreover, the tabletop device can be wirelessly charged by a docking station. The docking station further includes a plurality of receptacle that receives multiple tabletop devices.

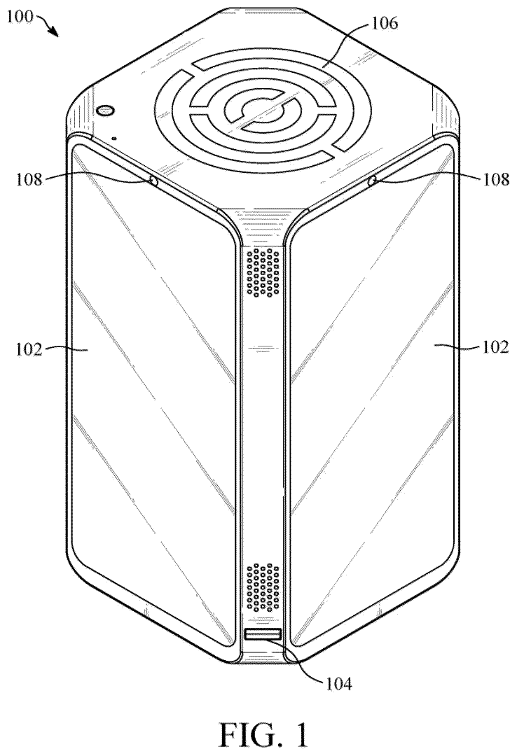

Referring now to FIG. 1 of the present invention illustrating a perspective view of a tabletop device 100 in accordance with an embodiment of the invention. The tabletop device 100 is a portable display device that can be used as a table advertisement player in places where manual service is not needed or less required; for example, the tabletop device 100 can be used in restaurants and cafes for taking orders and displaying menus. In some embodiments, the tabletop device 100 can be used in hospitals, malls, offices, and events for displaying information related to goods and services. In some embodiments, the tabletop device 100 can be used for booking, advertising, and promoting products and services. Moreover, the tabletop device 100 can also be used as a charging station at different-different locations to provide charging support to users. The users can charge their devices such as smartphones, notebooks, tablets, watches, and wearable bands through wired or wireless connections.

In one embodiment, the tabletop device 100 includes an enclosure that is made of water-proof material and provides effective sealing against foreign bodies such as dirt, spillage, water particles, etc., The tabletop device 100 is preferably made of IP-67-rated material that is highly resistive to water particles and provides protection against complete water immersion for up to 30 minutes at depths between 15 cm and 1 meter. The ‘IP’ in ‘IP67’ stands for “Ingress Protection,” wherein the first digit of the IP rating denotes the protection against solids such as dirt, dust, microparticles, and tools. The second digit of the IP rating denotes the protection against liquids, including drips, sprays, and moisture. In an alternate embodiment, the tabletop device 100 can also be made of IP-65, and IP-66-rated material.

As shown in FIG. 1, the tabletop device 100 includes one or more display units 102 that displays information regarding the goods and services. The one or more display unit 102 is provided on the side surface of the tabletop device 100. Based on the aesthetics of the tabletop device 100, in some embodiment, the one or more display units 102 can be provided at other sides or surfaces of the tabletop device 100. In situations where the tabletop device 100 is placed at the center of the table, for example, in restaurants, the viewers can see the advertisement or menus from multiple directions. This structure of the tabletop device 100 allows the users and viewers to see the content from various angles and offers a wide range of viewing angles when compared to devices mentioned in the prior art.

In a preferred embodiment, the one or more display unit 102 includes a display screen made of light-emitting diode (LED) and high quality displays the advertisement and information. However, in alternate embodiments, the one or more display units 102 includes but is not limited to liquid crystal display (LCD) display, organic light-emitting diode (OLED) display, active-matrix organic light-emitting diode (AMOLED), electroluminescent display (ELD), thin-film transistor display (TFT), plasma display, quantum-dot display (QLED), and the like. In some embodiments, the one or more display units 102 can include a touch-responsive display that enhances the user or viewer experience of the tabletop device 100. The touch-responsive display is configured to receive input from the users or viewers. In one embodiment, the tabletop device 100 can display one or more advertisements on an individual tabletop device 100. With the help of a software program stored in other computing devices, a user can select the frequency of said data and control the individual display unit of tabletop device 100.

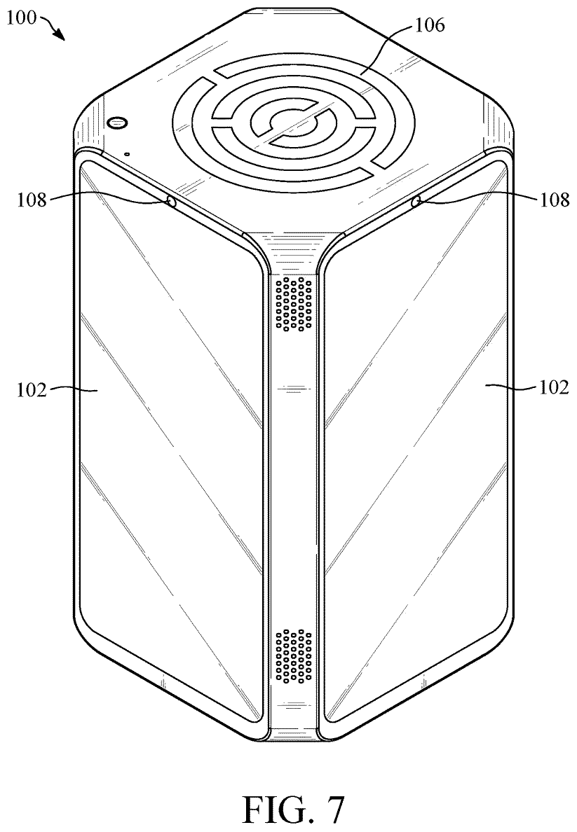

The tabletop device 100 further includes a plurality of charging ports 104 configured to charge the plurality of electronic devices through a cable or wired connection. In a preferred embodiment, the plurality of charging ports 104 are provided at each side of the tabletop device. By implementing this feature in the tabletop device 100, users can charge their electronic devices while watching the advertisements and information on the tabletop device 100. The electronic device includes but is not limited to a smartphone, notebook, tablet, laptop, smartwatches, wearable electronic devices, handheld computing devices, and personal digital assistants (PDA). In addition, the plurality of charging ports 104 allows the user to charge multiple devices simultaneously via cable or wired connection. The plurality of charging ports 104 includes a Universal Serial Bus (USB) A, B, or C type design or any other proprietary design depending upon the application of the tabletop device 100. However, it is not always necessary that tabletop device 100 must have the plurality of charging ports 104 at the bottom. In alternate embodiments, it may not include the plurality of charging ports 104 at the bottom and is configured to support wireless charging only (illustrated in FIG. 7).

Furthermore, the tabletop device 100 includes an inductive or wireless charging unit 106 configured to charge the electronic device wirelessly. In the preferred embodiment, the wireless charging unit 106 is provided at the upper or top surface of the tabletop device 100. In alternate embodiments, the wireless charging unit 106 can be provided at any location of the tabletop device 100, where the electronic device can be placed easily on the charging pads. More particularly, the wireless charging unit 106 includes an inductive coil that produces a magnetic field when a sufficient amount of electric power is passed through it. The produced magnetic field supplies the power to the electronic device and charges wirelessly.

In the preferred embodiment, the inductive coil is made of copper material. In one embodiment, the tabletop device 100 employs the ‘Apple Magsafe technology to provide the proper alignment of the other wireless devices with respect to the tabletop device 100. ‘Magsafe’ includes a series of magnets that are placed around the inductive coil of the tabletop device 100. The series of magnets can sense the other ‘MagSafe’ compatible accessories present within the other wireless devices and snap or secure with them seamlessly to provide a stable connection. In a preferred embodiment, the tabletop device 100 is further supported by a mounting panel configured to firmly hold the tabletop device 100. The mounting panel can be pre-installed on the table and employs a magnetic mechanism to connect with the tabletop device 100. The bottom surface of the tabletop device 100 includes a magnet that attracts the other magnet having an opposite polarity that is provided in the mounting panel. The magnetic connection between the tabletop device 100 and the mounting panel provides stability and protects against accidental knocks.

In some embodiments, the tabletop device 100 also includes a camera unit 108 that captures the image of the users and viewers near the tabletop device 100. The image taken or captured by the camera unit 108 can be further processed by the tabletop device 100 to perform facial recognition techniques. With the help of camera unit 108, the tabletop device 100 also analyzes the physical or suspicious activities of the user. Thus, the camera unit 108 of the tabletop device 100 enhances the security features and can also be employed for object detection. Furthermore, in one embodiment, the tabletop device 100 also includes a sensing unit 110 configured to detect the presence of a person or a living being near the tabletop device 100.

The sensing unit 110 comprises a plurality of sensors, such as proximity, motion, infrared, etc., that detect a person's presence. In these embodiments, the tabletop device 100 can be automatically turned off/on based on the output received from sensing unit 110. With the help of this feature, the energy consumption of the tabletop device 100 can be reduced and is available for a longer period. In addition, in certain embodiments, the tabletop device also includes a speaker or alarm unit that outputs the audio signal and a microphone unit for receiving the sound signal as the input of the user.

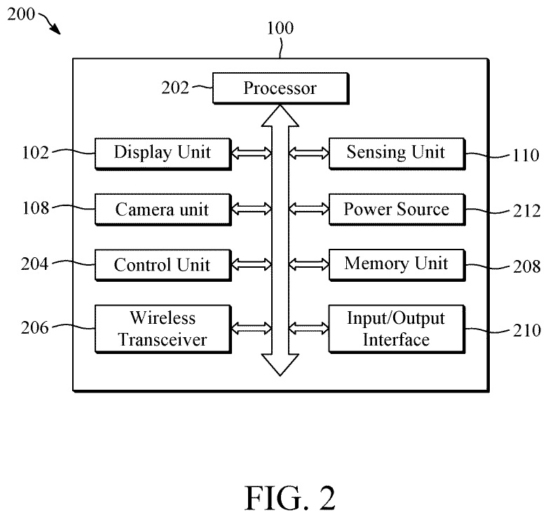

Referring now to FIG. 2 of the present invention illustrating a schematic block diagram 200 of the tabletop device 100 disclosed in FIG. 1, in accordance with an embodiment of the invention. The tabletop device 100 includes a processor 202 that process the advertisement data and the information related to goods and services received from external sources such as other computing devices or cloud server via a wired or wireless connection. Processor 202 executes the computing instructions of the program stored in the tabletop device 100 and outputs the signal based on the received input from external sources. The processor 202 is further coupled to a control unit 204 that controls the overall functioning of the tabletop device 100.

The tabletop device 100 also includes a wireless transceiver 206 configured to transmit and receive information related to goods and services wirelessly from other computing devices such as smartphones, personal computers (PC), laptops, tablets, handheld computing devices, and the like. In some embodiments, the data and information related to goods and services can be uploaded or downloaded from the cloud server via the internet. The wireless transceiver 206 employs different wireless mediums to receive and transmit advertising data and information. The wireless medium includes but is not limited to Bluetooth, ZigBee, Ethernet, Wireless Fidelity (Wi-Fi), Near Field Communication (NFC), and the like.

In one embodiment, the tabletop device 100 employs the Saas (software-as-a-service) technology to upload advertisement data and information. “SaaS or software-as-a-service” is a way of delivering applications over the internet—as a service. Instead of installing and maintaining software, a user can simply access it via the internet. It prevents users from downloading complex software and purchasing external hardware units. The SaaS technology allows venue owners and advertisers to create adverts and campaigns automatically synced across the network for tabletop device 100. The SaaS technology further provides users an enhanced and much-improved working experience.

The tabletop device 100 includes a memory unit 208 that is communicably coupled to the processor 202 and configured to store the information and advertising data received from external sources. Memory unit 208 also stores one or more features associated with the advertisement data; for example, it stores the running time, frequency, file size, frame rate, and the like of the advertisement. The processor 202 is further coupled to the plurality of elements, such as one or more display units 102, the camera unit 108, and sensing unit 110 of the tabletop device 100. Processor 202 further controls the display screens of the individual display unit and can be programmed to display the different-different data on each display unit.

The tabletop device 100 further includes an input-output (I/O) interface 210 that connects the device with electronic devices. The input-output interface 210 may include a plurality of charging ports 104, a speaker, and a microphone for transmitting and receiving the signal. The tabletop device 100 further comprises a power source 212 configured to provide electric power to the tabletop device 100. In the preferred embodiment, power source 212 includes one or more rechargeable batteries that provide electric power. The rechargeable battery is selected from a group of lead-acid, nickel-cadmium (NiCd), nickel-metal hydride (NiMH), lithium-ion (Li-ion), lithium-ion polymer (LiPo), or rechargeable alkaline batteries.

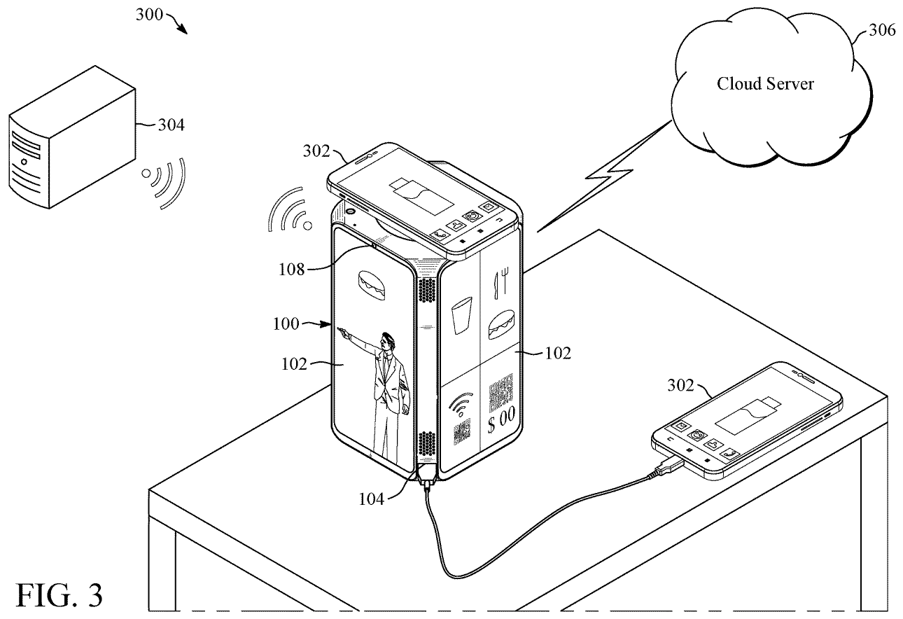

Referring now to FIG. 3 of the present invention illustrating a schematic configuration 300 of the tabletop device 100 with the plurality of electronic devices 302, in accordance with an embodiment of the invention. The schematic configuration 300 of the invention also illustrates the wireless transmission of the tabletop device 100 with the other computing device 304. The computing device 304 includes but is not limited to smartphones, personal computers (PC), laptops, notebooks, smartwatches, and handheld computing devices. In the preferred embodiment, the computing device 304 is provided at the remote location from the tabletop device 100 and is configured to transmit or receive the advertisement data and information related to goods and services to/from the tabletop device 100 wirelessly. In alternate embodiments, the computing device 304 can be present at the same location and connects with the tabletop device 100 through a wired or cable connection.

The computing device 304 also includes a processor that processes the information related to the goods and services and executes a program to convert the information into a digital signal. The converted digital signal is further transmitted to the tabletop device 100 via a wired or wireless connection. In the preferred embodiment, the computing device 304 may include a software program that allows the user to upload the advertisement content and information related to goods and services in a more convenient way. The software program includes a set of computing instructions that are executed to control the functioning of the tabletop device 100. In some embodiments, the advertisement data and information related to the goods and services can be uploaded from a cloud server 306 via the internet.

The computing device 304 may employ a SaaS-based technology to upload the advertisement data and information to the tabletop device 100. SaaS or software-as-a-service is a method of delivering applications over the internet—as a service. Instead of installing and maintaining software, a user can simply access the software via the internet. The SaaS technology allows the users such as venue owners and advertisers to create adverts and campaigns that automatically sync across the network for the tabletop device 100. The SaaS technology further provides users an enhanced and much-improved working experience. In some embodiments, the computing device 304 can utilize other wireless mediums such as Bluetooth, ZigBee, Ethernet, Wireless Fidelity (Wi-Fi), Near Field Communication (NFC), and any other technology to transfer the advertisement data and information wirelessly.

The schematic configuration 300 also illustrates the plurality of electronic devices 302 that are charged by the tabletop device 100 through a wired or wireless connection. The plurality of electronic devices 302 includes smartphones, smartwatches, notebooks, tablets, laptops, handheld computing devices, personal digital assistants (PDA), headphones, and the like. The plurality of electronic devices 302 can be physically charged via a plurality of charging ports 104. The charging ports include a Universal Serial Bus (USB) A, B, or C type design or any other proprietary design depending upon the application of the tabletop device 100. In case the plurality of electronic devices 302 supports wireless charging, the said devices can be wirelessly charged via a wireless charging unit 106 provided at the top surface of the tabletop device 100. The wireless charging unit 106 includes a charging coil, preferably made of copper, that produces a magnetic field when a sufficient amount of electric current passes through it.

FIG. 3 also illustrates the tabletop device 100 having the functionality of a micro-kiosk, in accordance with an embodiment of the present invention. While functioning as a micro-kiosk, the tabletop device 100 may provide information related to goods and services through the one or more display units 102. The tabletop device 100 as a micro-kiosk makes a wide range of interactions possible through the one or more display units 102. These interactions may include ordering items, providing or receiving feedback, viewing advertisements, and exchanging other kinds of information.

For example, information related to goods and services may include a menu for receiving orders. In that manner, a user may place an order using the menu. Alternatively, the user may choose to repeat their last order. In several embodiments, the displayed information may also include the option to request a server. On requesting the server, a server may present themselves to the user at the table. There may be another menu displaying information for connecting to in-house Wi-Fi. For example, on clicking the menu item, the username and the password for the in-house Wi-Fi may be displayed. Another menu item may provide option for receiving feedback on goods and services.

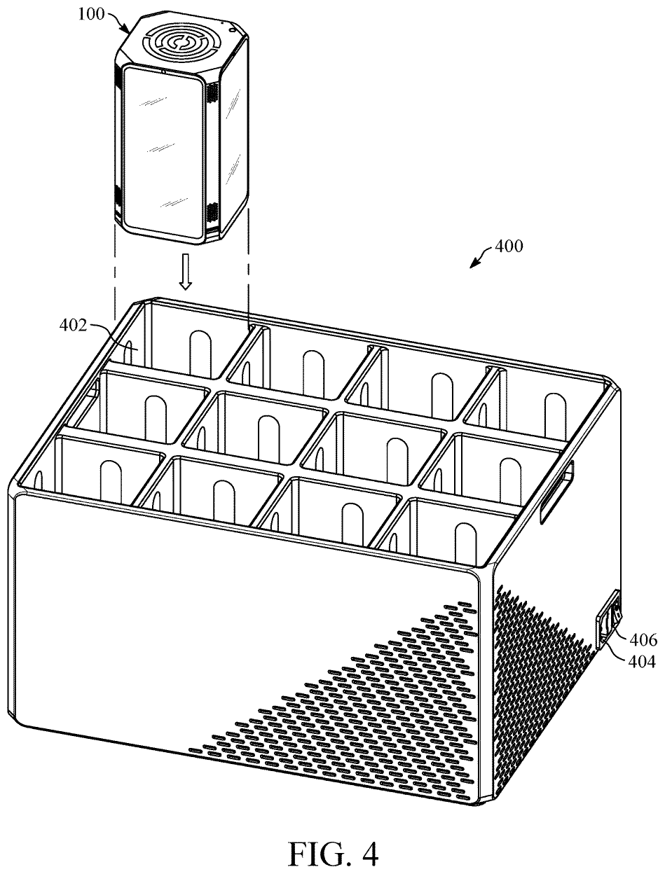

Referring now to FIG. 4 of the present invention illustrating a perspective view of a docking station 400, in accordance with an embodiment of the invention. The docking station 400 is provided to wirelessly charge the multiple tabletop devices 100 together. The docking station 400 includes a plurality of receptacles 402 configured to receive the multiple tabletop devices 100. The plurality of receptacles 402 firmly holds the multiple tabletop device through a locking mechanism. The locking mechanism includes but is not limited to the magnetic, snap and fit, threaded, and the like. In one embodiment, the docking station 400 also employs the ‘Apple Magsafe’ technology to firmly hold the tabletop device 100 within the plurality of receptacles 402. The internal architecture of the plurality of receptacles 402 preferably has a structure that facilitates the smooth insertion of the tabletop device 100 within the docking station.

The docking station 400 further includes a plurality of wireless charging units configured to charge multiple tabletop devices 100 efficiently. The plurality of charging units includes a charging or inductive coil that produces a magnetic field when a sufficient amount of electric current passes through it. The produced magnetic transfers the electric charge to the power source of the tabletop device 100 wirelessly. The electric current can be provided to the docking station 400 through a power socket 404 connected to the main power supply. In some embodiments, the docking station 400 may include a rechargeable battery to provide electric power.

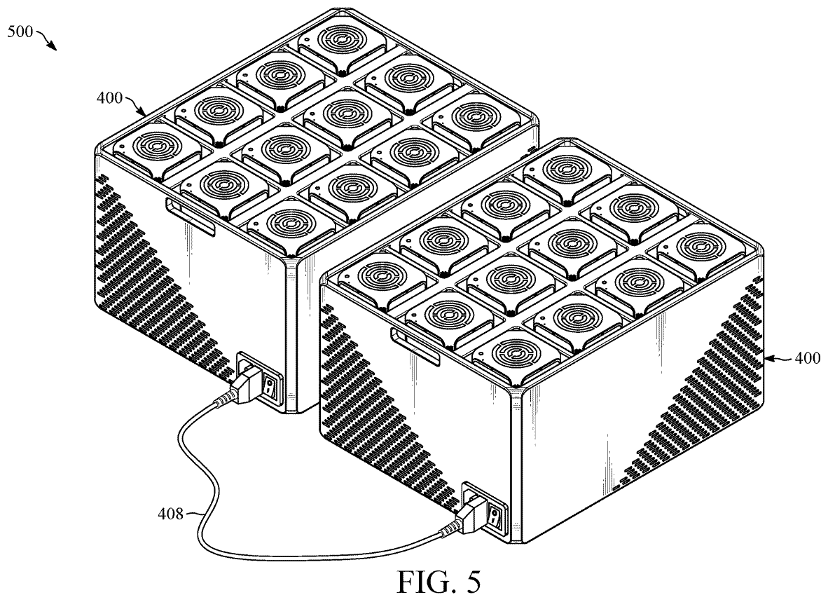

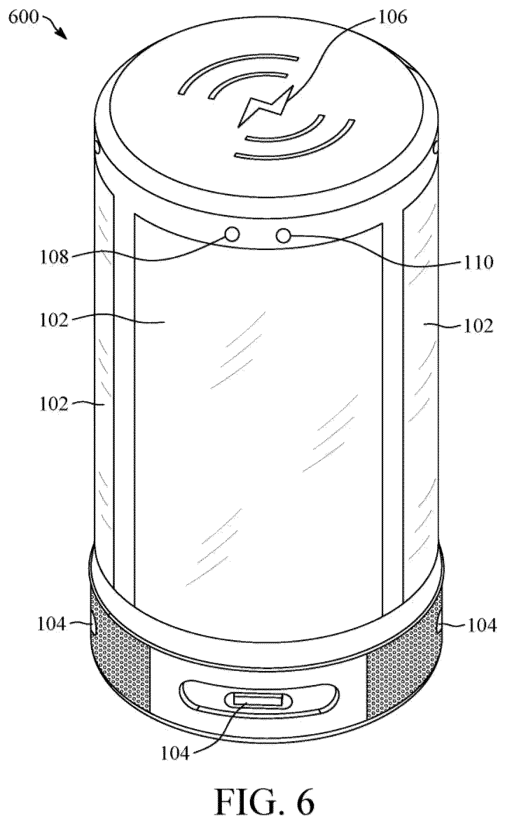

In one embodiment, the docking station 400 further includes a plurality of electrical terminals configured to charge the multiple tabletop devices 100 through a physical connection. For physical charging, the plurality of electrical terminals transfers the electrical power when connected to the respective terminals of the tabletop device 100 and charges the devices accordingly. In the preferred embodiment, the docking station 400 further includes an in-built fan that helps in removing or reducing the excess heat produced during the charging of the multiple tabletop device 100. In one embodiment, the docking station 400 further includes a connecting terminal 406 provided at one end, configured to connect the multiple docking stations for charging purposes. The connecting terminal 406 connects the multiple docking stations via the connecting cable 408 (illustrated in FIG. 5). In several embodiments of the invention, the tabletop device 100 is of square cross-section as illustrated in FIGS. 1, 3, 4, 5, and FIG. 7. In several alternate embodiments, the tabletop device 100 is of circular cross-section as illustrated in FIG. 6.

The present invention has been described with reference to exemplary embodiments. However, it will be readily apparent to those skilled in the art that it is possible to embody the invention in specific forms depending on an application other than those of the exemplary embodiments described above. This may be done without departing from the spirit of the invention. The described embodiments are merely illustrative and should not be considered restrictive in any way. The scope of the invention is given by the appended claims and their equivalents rather than the preceding description. All variations and equivalents that fall within the range of the claims are intended to be embraced therein. Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given application.

1. A tabletop display device for advertising information with wireless charging support, the tabletop display device comprising:
an enclosure made up of a waterproof material, the enclosure comprising:
one or more display units configured to display information related to goods and services;
a plurality of charging ports configured to charge a plurality of electronic devices through a wired connection;
a wireless charging unit configured to charge the plurality of electronic devices wirelessly;
a camera unit configured to capture images of users and viewers;
a sensing unit configured to detect a presence of a person or a living being;
a control unit configured to automatically turn the tabletop display device on or off based on an output received from the sensing unit, thereby reducing energy consumption;
a processor configured to:
process advertisement data and the information related to the goods and services received as inputs from external sources, and
execute the computing instructions and output signals based on the received inputs from the external sources;
a memory unit communicably coupled to the processor and configured to store the information related to the goods and services, the advertising data received from the external sources, and one or more features associated with the advertisement data, wherein the one or more features include a running time, a frequency, a file size, and a frame rate of an advertisement;
a wireless transceiver configured to transmit and receive the information related to the goods and services wirelessly to and from other computing devices, respectively; and
a power source configured to provide electric power to the tabletop display device.

2. The tabletop display device as claimed in claim 1, wherein the wireless charging unit is provided at an upper surface of the tabletop display device.

3. The tabletop display device as claimed in claim 1, further comprising a speaker and/or an alarm unit configured to output an audio signal and a microphone unit configured for receiving a sound signal as input from a user.

4. The tabletop display device as claimed in claim 1, wherein the power source includes one or more rechargeable batteries that provide the electric power.

5. The tabletop display device as claimed in claim 4, wherein the rechargeable battery is selected from a group of lead-acid, nickel-cadmium (Ni—Cd), nickel-metal hydride (NiMH), lithium-ion (Li-ion), lithium-ion polymer (LiPo), or rechargeable alkaline batteries.

6. The tabletop display device as claimed in claim 1, wherein the computing instructions include instructions for allowing a user to upload or download the advertisement data and the information related to the goods and services.

7. The tabletop display device as claimed in claim 6, wherein the computing instructions include instructions to upload or download the advertisement data and the information related to the goods and services to or from a cloud server, respectively, via the internet, the cloud server being a Software-as-a-Service (SaaS) based cloud server.

8. The tabletop display device as claimed in claim 1, wherein the information related to the goods and services includes menus for receiving orders, requesting a server, repeating a last order, connecting to an in-house Wi-Fi, and receiving feedback from the customers.

9. A docking station comprising a plurality of receptacles configured to receive a plurality of tabletop display devices and charge the plurality of tabletop display devices through wired or wireless means, wherein each one of the plurality of tabletop display devices comprises:
an enclosure comprising:
one or more display units configured to display information related to goods and services;
a plurality of charging ports configured to charge a plurality of electronic devices through a wired connection;
a wireless charging unit configured to charge the plurality of electronic devices wirelessly;
a camera unit configured to capture images of users and viewers;
a sensing unit configured to detect a presence of a person or a living being;
a processor configured to:
process advertisement data and the information related to the goods and services received as inputs from external sources, and
execute the computing instructions and output signals based on the received inputs from the external sources;
a memory unit communicably coupled to the processor and configured to store the information and the advertising data received from external sources;
a wireless transceiver configured to transmit and receive the information related to the goods and services wirelessly to and from other computing devices, respectively; and
a power source configured to provide electric power to the tabletop display device.

10. The docking station as claimed in claim 9, further comprising an in-built fan configured to remove or reduce excess heat produced during charging of the plurality of tabletop display devices.

11. The docking station as claimed in claim 9, further comprising a connecting terminal configured to connect the docking station with another docking station via a connecting cable.
